(19) United States
(12) Patent Application Publication
(10) Pub. No.: US 2006/0109854 A1
(43) Pub. Date: May 25, 2006

(54) Systems and methods to share information between digital video recorders

(76) Inventor: Ramon C. Cancel, Hillsboro, OR (US)

Correspondence Address: BUCKLEY, MASCHOFF, TALWALKAR LLC, 5 ELM STREET, NEW CANAAN, CT, 06840, US

(21) Appl. No.: 10/994,735

(22) Filed: Nov. 22, 2004

(51) Int. Cl. H04L 12/56

(52) U.S. Cl. 370/401; 435/252

(57) ABSTRACT

According to some embodiments, information may be shared between digital video recorders. In some embodiments, systems or methods may include, for example, identifying first information associated with a first user of a first digital video recorder, and providing the first information to a second digital video recorder. Some embodiments may further include receiving second information associated with a second user of the second digital video recorder, and providing the second information to the first user.

### BACKGROUND

Digital Video Recorder (DVR) devices and services, such as those provided by TiVo®, Inc. and Digital Networks North America, Inc. (ReplayTV®), allow users to record, pause, and even rewind broadcast media. Advances in DVR device technology now also allow users to access the recorded media via devices connected to their home network. Some DVR devices are even capable of being connected to other DVR devices within the same home network. If a user wishes to share recorded information with friends, family, and/or co-workers, however, the recorded media must be exported to a different device that is capable of facilitating media distribution. Some information associated with the DVR device may not be exportable.

### BRIEF DESCRIPTION OF THE DRAWINGS

FIG. 1 is a block diagram of a system.

FIG. 2 is a block diagram of a system according to some embodiments.

FIG. 3 is a flow diagram of a method according to some embodiments.

FIG. 4 is a block diagram of a system according to some embodiments.

FIG. 5 is a block diagram of a system according to some embodiments.

### DETAILED DESCRIPTION

Some embodiments herein are associated with “information” or “data”. As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encrypted, and/or otherwise packaged or manipulated in accordance with any method that is or becomes known.

In addition, some embodiments described herein are associated with “information indicative of” or “indicia” of information associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information.

Some embodiments described herein are associated with a “user device”. As used herein, the term “user device” may refer to any device that can interface with and/or be controlled or manipulated by a user and/or that is capable of communicating via a network. Examples of user devices include a Personal Computer (PC) device, a computer workstation, a computer server, a printer, a scanner, a facsimile machine, a copier, a Personal Digital Assistant (PDA), a storage device (e.g., a disk drive), a hub, a router, a switch, and a communication device (e.g., a modem or a wireless phone). User devices may comprise one or more components, such as a Static Random Access Memory (SRAM) device or module, a network processor, and a network communication path, connection, port, or cable.

In addition, some embodiments are associated with a “network” or a “communication network”. As used herein, the terms “network” and “communication network” may be associated with the transmission of messages, packets, signals, and/or other forms of information between and/or within one or more network devices. By way of example, a network may be configured to operate in accordance with the Fast Ethernet LAN transmission standard 802.3-2002® published by the Institute of Electrical and Electronics Engineers (IEEE) and/or in accordance with IPv6.

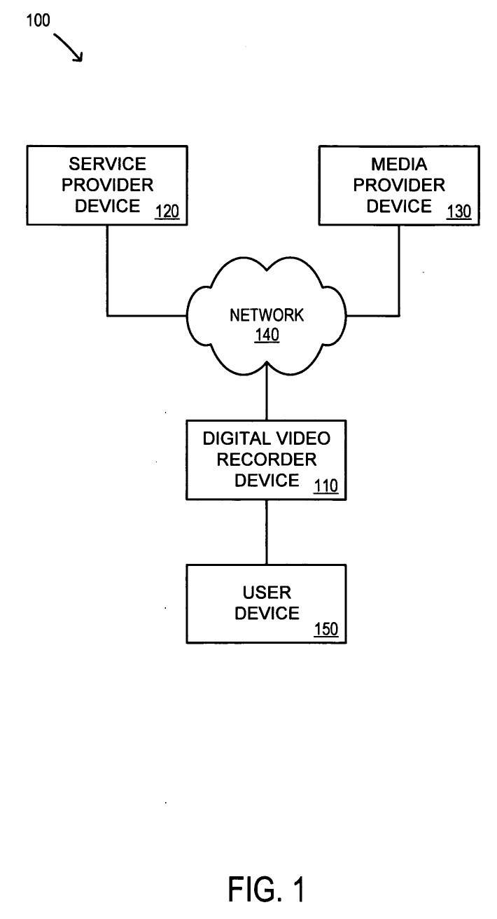

Referring first to FIG. 1, a block diagram of a system 100 is shown. The various systems described herein are depicted for use in explanation, but not limitation, of described embodiments. Different types, layouts, quantities, and configurations of any of the systems described herein may be used without deviating from the scope of some embodiments. Fewer or more components than are shown in relation to the systems described herein may be utilized without deviating from some embodiments.

The system 100 may comprise, for example, a Digital Video Recorder (DVR) device 110. In some configurations, the DVR device 110 may be in communication with a service provider device 120 and/or a media provider device 130. The DVR device 110, the service provider device 120, and/or the media provider device 130 may, for example, communicate via the network 140. The network 140 may be or include any type and/or configuration of network that is or becomes known or practicable. The network 140 may, for example, be the Internet or another IP network. In some configurations, the network 140 may comprise any number of networks of varying types and/or configurations. The DVR device 110 may, for example, communicate with the service provider device 120 over a Public Switched Telephone Network (PSTN) and/or may communicate with the media provider device 130 using a cable or satellite connection.

The service provider device 120 may be a device operated and/or owned by and/or otherwise associated with a provider of DVR devices and/or services, such as TiVo®, Inc. The media provider device 130 may be owned, operated, and/or otherwise associated with a provider of broadcast services and/or other media services such as Cablevision®, DirecTV®, or Kodak®'s Ofoto.com™. The DVR device 110 may receive information from the service provider device 120 and/or the media provider device 130 (e.g., via the network 140 such as a cable and/or satellite network). The service provider device 120 may, for example, provide the DVR device 110 with scheduling information associated with the media provider device 130. The media provider device 130 may provide the DVR device 110 with various media such as broadcast programming and/or other audio or video media. In some configurations, the DVR device 110 may utilize the scheduling information provided by the service provider device 120 to identify and/or record portions of the media provided by the media provider device 130. Also in some configurations, the service provider device 120 and the media provider device 130 may be or include the same device and/or may be operated, owned, and/or otherwise associated with the same entity (e.g., Cablevision® may provide both media and media scheduling services).

The DVR device 110 may also or alternatively interface and/or be in communication with a user device 150. The user device 150 may be any type of device that is associated with a user. The user device 110 may, for example, be or include a display device (such as a TV), a PC, and/or a remote control device. In some configurations, the DVR device 110 may be directly connected to, coupled with, and/or otherwise in communication with the user device 150 (e.g., via a cable and/or wireless connection). The user device 150 may also or alternatively be in communication with the DVR device 110 via a network (e.g., similar to and/or including the network 140). The user device 150 may provide input to the DVR device 110 (e.g., commands and/or media) and/or may receive output from the DVR device 110 (e.g., recorded media). In some configurations, the DVR device 110 may be or include one or more user devices 150.

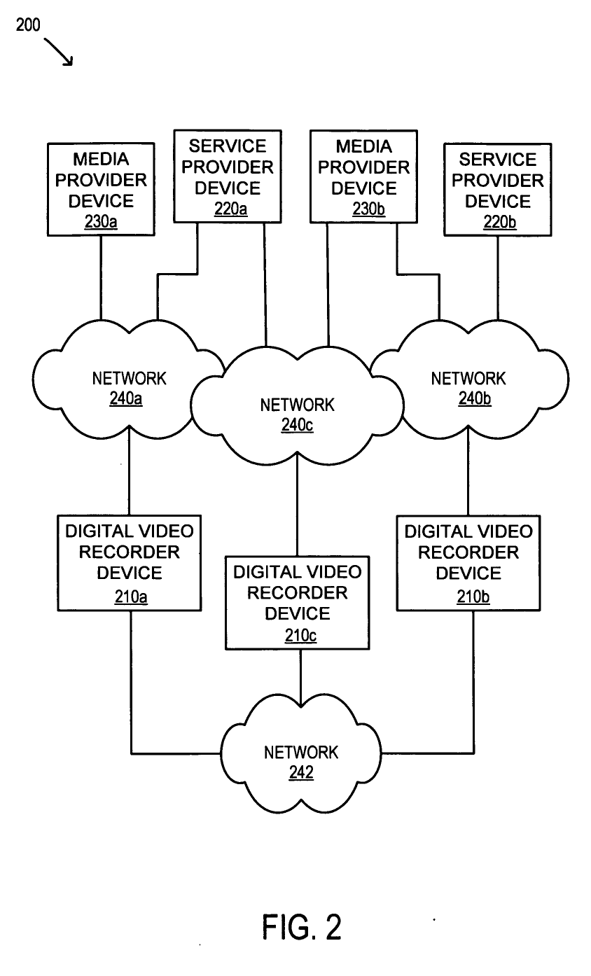

Referring in more detail to FIG. 2, a block diagram of a system 200 according to some embodiments is shown. The system 200 may include, according to some embodiments, one or more DVR devices 210a-c, one or more service provider devices 220a-b, one or more media provider devices 230a-b, and/or one or more networks 240a-c, 242. Any of the devices 210a-c, 220a-b, 230a-b may, according to some embodiments, be in communication with any other of the devices 210a-c, 220a-b, 230a-b (e.g., via the networks 240a-c, 242). In some embodiments, the components 210a-c, 220a-b, 230a-b, 240a-c, 242 of the system 200 may be similar in configuration and/or functionality to the similarly-named components described in conjunction with FIG. 1. In some embodiments, fewer or more components than are shown in FIG. 2 may be included in the system 200.

In some embodiments, the first DVR device 210a may be associated with the first service provider device 220a and/or the first media provider device 230a. According to some embodiments, the first service provider device 220a may also or alternatively be associated with the third DVR device 210c. Similarly, the second DVR device 210b may be associated with the second service provider device 220b and/or the second media provider device 230b. The second media provider device 230b may, according to some embodiments, be associated with the third DVR device 210c. For example, the first and third DVR devices 210a, 210c may be provided with services (e.g., scheduling lineups or other subscription services) from the same entity (e.g., an entity associated with the first service provider device 220a). In some embodiments, the second and third DVR devices 210b, 210c may receive media from the same entity (e.g., the entity associated with the second media provider device 230b).

In some embodiments, the DVR devices 210a-c may be associated with various users (not shown). For example, the first, second, and third DVR devices 210a, 210b, 210c may be associated with first, second, and third users, respectively. In some embodiments, more than one user may be associated with a DVR device 210a-c. In the case that a DVR device 210a-c is utilized by a family, for example, each member of the family that interacts with the DVR device 210a-c may be a user associated with the DVR device 210a-c. In some embodiments, the entire family may be considered a single user (e.g., a user group).

According to some embodiments, the first, second, and third DVR devices 210a, 210b, 210c may communicate with the various service provider devices 220a-b and media provider devices 230a-b via the first, second, and third networks 240a, 240b, 240c, respectively. The networks 240a-c may, in some embodiments, be or include a single network and/or a group of related sub-networks, or may be or include multiple networks (e.g., as shown in FIG. 2). The networks 240a-c may be similar in type and/or configuration or may be different. For example, the first DVR device 210a may communicate with the first service provider device 220a and/or the first media provider device 230a via the first network 240a, which may, for example, be a PSTN or Digital Subscriber Line (DSL) network and/or connection. The second DVR device 210b may communicate with the second service provider device 220b and/or the second media provider device 230b via the second network 240b, which may, for example, be an IP network such as the Internet.

In some embodiments, the DVR devices 210a-c may also or alternatively communicate with one another. The DVR devices 210a-c may, for example, be capable of sharing information via the network 242. According to some embodiments, the network 242 may be or include an IP network, a Local Area Network (LAN), Wide Area Network (WAN), and/or any other type of wired and/or wireless network that is or becomes known or practicable. In some embodiments, the network 242 may be or include one or more of the networks 240a-c. For example, the DVR devices 210a-c may communicate both with each other and with the service and media providing devices 220a-b, 230a-b via a single network.

According to some embodiments, the DVR devices 210a-c may be operable to share information. In some embodiments for example, the first user (e.g., operating the first DVR device 210a) may wish to share recorded media with the second user (e.g., operating the second DVR device 210b). Instead of exporting the recorded media from the first DVR device 210a to another device such as a Video Cassette Recorder (VCR) or another removable storage medium (as is required in typical DVR systems), the first user may, for example, simply select the media to be shared (e.g., using a Graphical User Interface (GUI) provided by the first DVR device 210a). In some embodiments, the first DVR device 210a may automatically send and/or provide the selected media to the second DVR device 210b.

According to some embodiments, such as in the case that the first media provider device 230a is associated with a different media provider than the second media provider device 230b, the media provided by the first DVR device 210a may be media that the second DVR device 210b otherwise may not have access to. For example, the first media provider device 230a may be associated with a provider of digital music, while the second media provider device 230b may be associated with a cable television provider. In some embodiments, the first user may provide digital music to the second user (e.g., who may not otherwise have access to the digital music) and/or the second user may provide cable television programming to the first user (e.g., who may not otherwise have access to the cable television programming). According to some embodiments, such as where copyright laws and/or regulations may be of concern, the DVR devices 210a-c may be operable only to share media that does not violate any applicable laws and/or regulations. In some embodiments for example, the DVR devices 210a-c may be configured to exchange and/or swap media in an acceptable manner.

In some embodiments, such as in the case that the first service provider device 220a is associated with a different service provider than the second service provider device 220b, the DVR devices 210a-c may be operable to share information and/or otherwise communicate even though they are serviced by different entities. For example, the first DVR device 210a may be a TiVo® DVR and/or the second DVR device 210b may be a ReplayTV® DVR. According to some embodiments, even though the first and second DVR devices 210a-b are owned by, serviced by, managed by, and/or otherwise associated with different DVR service providers, the first and second DVR devices 210a-b may be capable of sharing information and/or otherwise communicating (e.g., via the network 242). In such a manner, for example, a user may share DVR information with other users regardless of the make, model, manufacture, and/or provider of the DVR devices 210a-c.

According to some embodiments, the information shared, transmitted, and/or received via the network 242 may include various types of information associated with the DVR devices 210a-c. The information may include, for example, recorded media, streaming media, media schedules and/or other schedules, and/or user-defined information such as user recommendations, comments, and/or messages. In the case that two DVR devices 210a-c are associated with the same media provider device 230a-b, such as where the second and third DVR devices 210b-c are associated with the second media provider device 120b, the information transmitted between the two DVR devices 210b-c may include one or more schedules and/or other information associated with the media provided by the second media provider device 230b. The second DVR device 210b may be utilized, for example, to send a broadcast media schedule (such as a TV program listing) to the third DVR device 210c.

In some embodiments, the schedule may not otherwise be accessible to the third DVR device 210c (e.g., the network 240c connection between the third DVR device 210c and the second media provider device 230b may be inaccessible). According to some embodiments, the scheduling (and/or other information) may be processed and/or otherwise utilized by the third DVR device 210c. For example, in the case that the third DVR device 210c receives a TV listing from the second DVR device 210b, the third DVR device 210c may utilize the listing to identify, display, and/or record TV broadcasts (e.g., received from the second media provider device 230b). In some embodiments, the scheduling information may be or include information relating to a viewing and/or recording schedule associated with the second DVR device 210b.

The second user may, for example, program the second DVR device 210b to record certain programs. In some embodiments, the second user may send and/or provide the recording schedule to the third DVR device 210c (e.g., operated by a friend or family member). The third DVR device 210c may, according to some embodiments, utilize the recording schedule from the second DVR device 210b to determine one or more TV programs to be recorded by the third DVR device 210c. In such a manner, for example, a DVR device 210a-c may automatically schedule recordings of media based upon recording schedules associated with other DVR device 210a-c.

In some embodiments, the information transmitted between DVR devices 210a-c may also or alternatively include user recommendations. User ratings, reviews, comments, and/or other information may, for example, be shared between the DVR devices 210a-c. According to some embodiments, user recommendations may also or alternatively be provided to one or more service provider devices 220a-b. Any given service provider may, for example, collect ratings and/or recommendations from any or all associated users (e.g., any or all cable television subscribers). The combined, totaled, averaged, and/or otherwise tabulated or processed ratings may then, for example, be provided to the users (e.g., to show which programs are most or least popular). In some embodiments, the DVR devices 210a-c may utilize media ratings in determining which media to record. In other words, a user may command a DVR device 210a-c to record the most popular TV shows and/or other programs.

The information shared between the DVR devices 210a-c may, according to some embodiments, be shared through the use of one or more GUI devices and/or lists. The first user may, for example, maintain a contact list (and/or multiple contact lists) including information associated with various DVR devices 210a-c and/or the users associated with those devices. In some embodiments, the contact list may be similar to a “buddy list” and/or other contact list that is utilized in various communications programs such as Microsoft® Outlook™, ICQ®, AOL® Instant Messenger™ (IM), and/or MSN® Messenger™. According to some embodiments, the contact lists on the DVR devices 210a-c may be downloaded from and/or otherwise interfaced or associated with the lists from other programs.

The DVR devices 210a-c may, for example, interface with other programs and/or devices (such as an IM program operating on a user's PC) to obtain, update, and/or otherwise utilize lists and/or other information associated with contacts. According to some embodiments, the DVR devices 210a-c may include a module, program, add-in, thin-client, and/or other instructions that facilitate interaction between the DVR devices 210a-c and one or more other programs or devices (such as user devices). In some embodiments, the contact list information (and/or any portion thereof) may also or alternatively be obtained from one of the service provider devices 220a-b and/or one of the media provider devices 230a-b. The DVR devices 210a-c may, for example, be provided contact information associated with service provider and/or media provider subscribers (e.g., TiVo® and/or DirecTV® subscribers).

The contact list may be used, for example, by a user to share information with and/or otherwise communicate with other users and/or other DVR devices 210a-c. In some embodiments, the first user may be able to browse media and/or other content stored on DVR devices 210b-c owned and/or operated by other users. The first user may, for example, be able to view stored digital photographs residing on the second user's DVR device 210b. According to some embodiments, the first user may select media stored on the second DVR device 210b and may, for example, download and/or view the selected media. In such a manner, for example, users of DVR devices 210a-c may easily share media such as digital photographs. In some embodiments, users may be able to restrict access to media stored on their associated DVR device 210a-c. Private and/or other information not desirable for dissemination (e.g., copyrighted material or personal information) may, for example, be “hidden” from one or more other users. According to some embodiments, different access rights may be established for any number of users and or user groups.

In some embodiments, for example, users may manipulate the contact list to designate various user groups such as “friends”, “family”, “co-workers”, etc. Users may then establish various rules and/or other limitations and/or permissions that govern access to DVR information. As an example, the first user may download an ICQ® buddy list from the user's PC to the first DVR device 210a. In some embodiments, the information received from the PC may be used to identify various users, user attributes, and/or user group information which may, for example, be automatically adopted by the first DVR device 210a. The ICQ® list may, for example, include information associated with the second user, such as information identifying address and/or contact information associated with the second DVR device 210b. In some embodiments, the list downloaded by and/or created by the first DVR device 210a may include an identifier associated with the second DVR device 210b such as an IP address and/or Uniform Resource Locator (URL).

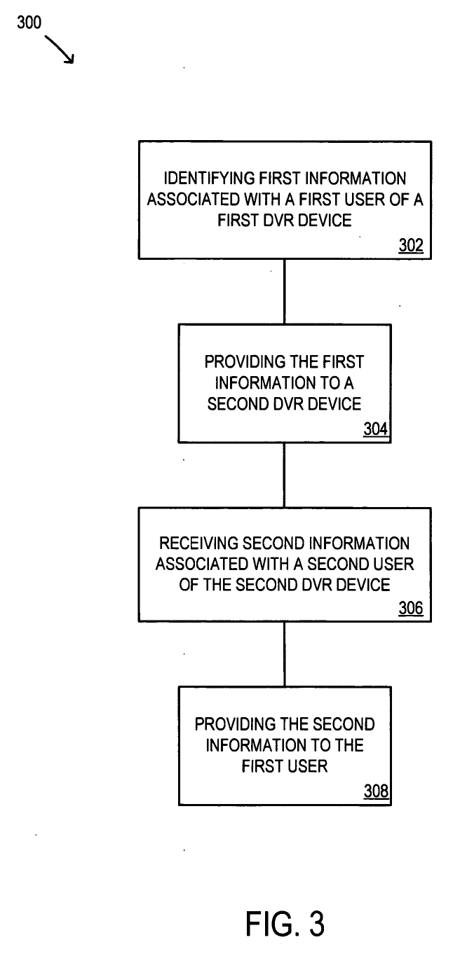

Referring now to FIG. 3, a method 300 according to some embodiments is shown. In some embodiments, the method 300 may be conducted by and/or by utilizing the systems 100, 200 and/or may be otherwise associated with the systems 100, 200 and/or any of the system components described in conjunction with any of FIG. 1 and/or FIG. 2. The method 300 may, for example, be performed by and/or otherwise associated with the host device 120, 220 described herein. The flow diagrams described herein do not necessarily imply a fixed order to the actions, and embodiments may be performed in any order that is practicable. Note that any of the methods described herein may be performed by hardware, software (including microcode), firmware, manual means, or any combination thereof. For example, a storage medium may store thereon instructions that when executed by a machine result in performance according to any of the embodiments described herein.

In some embodiments, the method 300 may begin at 302 by identifying first information associated with a first user of a first DVR device. The first information may, for example, be or include scheduling information (such as TV listings and/or recording schedules), user recommendations, and/or recorded media. According to some embodiments, the first user may select, identify, create, and/or otherwise determine the first information. The first user may, for example, select the first information using a GUI. In some embodiments, the first information may also or alternatively be identified based on other factors. For example, the first information may be selected from a plurality of available information based on whether the information is otherwise available to other DVR devices and/or users. The first information may be rated and/or valued, according to some embodiments, and the information with the highest (or lowest) value and/or rating may be identified. According to some embodiments, the identification may be performed by the first DVR device.

The method 300 may continue, according to some embodiments, by providing the first information to a second DVR device, at 304. In some embodiments, the first DVR device may be coupled to the second DVR device. The DVR devices (such as the DVR devices 110, 210a-c) may, for example, be in communication via a network such as an IP network. In some embodiments, either or both of the DVR devices may be associated with identifiers (e.g., URL, IP, and/or other identifiers) that facilitate communication between the DVR devices. The first DVR device may be associated with a first IP address, for example, and the second DVR device may be associated with a second IP address. According to some embodiments, the first user may store contact information associated with a user of the second DVR device (e.g., in a contact list and/or file). The contact information may include, for example, the second IP address.

In such a manner for example, the first user may simply select the other user (e.g., from a list on a GUI) and the first DVR device may process the contact information to determine the second IP address. The first information may then, for example, be sent, transmitted, and/or otherwise provided to the second DVR device associated with the second IP address. In some embodiments, the first information may be sent to the second IP address as one or more IP packets over the IP network. According to some embodiments, the DVR devices may include special and/or dedicated ports that facilitate connection to the IP network and/or communication between the DVR devices. In some embodiments, the same ports, cables, connections, and/or networks that the DVR devices utilize to communicate with service providers and/or media providers may be utilized to initiate and/or facilitate communication between the DVR devices.

In some embodiments, the method 300 may continue at 306 by receiving second information associated with a second user of the second DVR device. The second information may, for example, be information similar to the first information. The second information may, according to some embodiments, include media, recommendations, and/or schedules associated with the second user (and/or with the second DVR device). In some embodiments, the second information may be information selected and/or identified by either or both of the second user and the second DVR device. The second information may be selected and sent and/or transmitted to the first DVR device, for example, in response to the providing of the first information.

According to some embodiments, the first and second information may be shared between the first and second users and/or between the first and second DVR devices. The first and second users may, for example, select information (e.g., the first and second information) that they wish to share, trade, and/or exchange. According to some embodiments, the users may share scheduling information. Instead of simply telling a friend or family member about a desirable show, for example, the first user may set the first DVR device to record the show (e.g., because the first user likes the show) and then simply provide the recording schedule of the first DVR device directly to the second user (and/or to the second DVR device). In some embodiments, the second DVR device may automatically adopt the recording schedule and/or the second user may easily (e.g., via a GUI) set the second DVR device to record the desired show in accordance with the received schedule. In some embodiments for example, the second user may not be required to take steps that would normally be required to set the second DVR device to record the desired show (e.g., searching for the show's listing and/r selecting recording options).

The method 300 may continue, in some embodiments, by providing the second information to the first user, at 308. In the case that the second information includes media, for example, the first DVR device may cause the second information to be displayed to the first user. In some embodiments, the receiving of the second information (e.g., at 306) may automatically cause the second information to be displayed and/or otherwise provided to the first user. As an example, the first user may utilize a GUI on the first DVR device to browse digital photo content stored on the second DVR device. The first user may select one or more digital photographs that are desired for viewing by providing input to the GUI (e.g., the first information identified at 302). The selection may be sent to the second DVR device (e.g., the providing at 304) and the second DVR device may transmit the selected digital photographs to the first DVR device (e.g., via a File Transfer Protocol (FTP) and/or other download). Upon receiving the downloaded digital photographs (e.g., at 306), the first DVR device may cause the photographs to be displayed (e.g., the providing at 308) on a user device such as a TV or other monitor or display device. In such a manner, for example, the users may easily and/or quickly share stored media (like digital photographs), recording schedules, recommendations, and/or other information, utilizing their respective DVR devices.

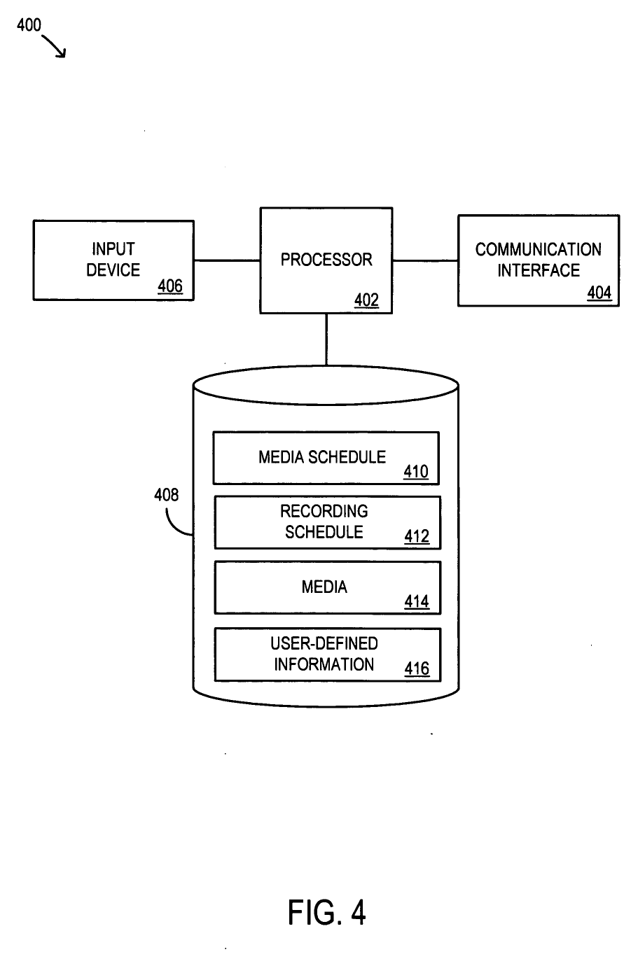

Turning now to FIG. 4, a block diagram of a system 400 according to some embodiments is shown. The system 400 may, for example, be utilized to implement and/or perform the method 300 described herein and/or may be associated with the systems 100, 200 described in conjunction with any of FIG. 1 and/or FIG. 2. In some embodiments, fewer or more components than are shown in FIG. 4 may be included in the system 400. According to some embodiments, different types, layouts, quantities, and configurations of systems may be used.

According to some embodiments, the system 400 may be a DVR device such as the DVR devices 110, 210a-c described herein. In some embodiments, the system 400 may be a DVR device that is capable of sharing content, schedules, and/or user recommendations with other DVR devices. The system 400 may include, for example, one or more processors 402, which may be any type or configuration of processor, microprocessor, and/or micro-engine that is or becomes known or available. In some embodiments, the system 400 may also or alternatively include one or more communication interfaces 404, an input device 406, and/or a memory device 408, all and/or any of which may be in communication with the processor 402. The memory device 408 may store, for example, a media schedule 410, a recording schedule 412, media 414, and/or user-defined information 416.

The communication interface 404 and/or the input device 406 may be or include any types and/or configurations of devices that are or become known or available. In some embodiments, the communication interface 404 may be or include an IP interface such as a Network Interface Card (NIC), a port, cable, and/or other connection. The communication interface 404 may include, for example, a port for receiving a connector configured in accordance with the Universal Serial Bus (USB) interface standard as described in the USB Specification Revision 2.0 (2000) and/or the Category 5-e (Cat5e) Cabling standard as described by the American Standards Institute/Telecommunications Industry Association/Electronic Industries Alliance (ANSI/TIA/EIA) 568-A-5 addendum (February 2000). According to some embodiments, the input device 406 may include a keypad, a touch screen device, one or more buttons, a remote control device, and/or one or more softkeys and/or variable function input devices.

The memory device 408 may be or include, according to some embodiments, one or more magnetic storage devices, such as hard disks, one or more optical storage devices, and/or solid state storage. The memory device 408 may store, for example, the media schedule 410, the recording schedule 412, the media 414, and/or the user-defined information 416. The media schedule 410 may be, for example, a schedule of TV, satellite, and/or other broadcast media. In some embodiments, the media schedule 410 may be utilized by the system 400 to facilitate identification of broadcast media that is capable of being recorded. The media schedule 410 may, for example, be provided to a user of the system 400 who may utilize the media schedule 410 to select programs that are desired to be recorded.

The programs the user selects may, according to some embodiments, be stored as the recording schedule 412. The recording schedule 412 may, for example, store various information associated with recording media. In some embodiments, the system 400 may utilize the recording schedule 412 to determine what media is to be recorded and at what times. According to some embodiments, the system 400 may select programs and/or other media (e.g., based on user preferences, likes/dislikes, habits, and/or recommendations) to be recorded and may store the appropriate information (e.g., time, date, program length, recording format, and/or other recording parameters) in the recording schedule 412.

The recording schedule 412 may, according to some embodiments, cause various audio, video, and/or other content to be saved as the media 414. The media 414 may include, for example, TV programs, digital pictures, videos, music (e.g., digital music), articles, messages, and/or other media content. In some embodiments, the media 414 may be received from a media provider and/or from other DVR devices or systems. The memory device 408 may also or alternatively store the user-defined information 416. The user-defined information 416 may include, for example, user recommendations, user preferences, messages, and/or other user-defined information. In some embodiments, the user of the system 400 may define one or more recording rules and/or procedures. According to some embodiments, the user may rate, rank, and/or value one or more portions and/or types of media (e.g., a particular TV program or movie) and store the information as user-defined information 416.

Any or all of the information 410, 412, 414, 416 stored by the memory device 408 may, according to some embodiments, be shared with other systems and/or DVR devices. In some embodiments for example, the processor 402 may be operable to execute instructions that cause the various information 410, 412, 414, 416 to be shared between DVR devices and/or to otherwise operated in accordance with embodiments described herein. According to some embodiments, the user of the system 400 may provide any of the information 410, 412, 414, 416 to another user operating a DVR device. The system 400 may also or alternatively receive some or all of the information 410, 412, 414, 416 from another system and/or DVR device (e.g., associated with another user).

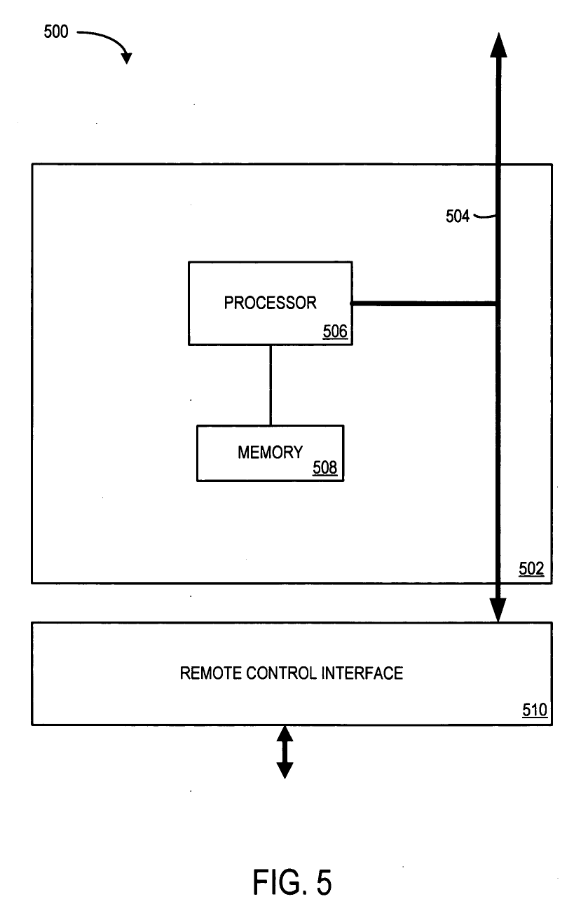

Turning now to FIG. 5, a block diagram of a system 500 according to some embodiments is shown. The system 500 may, for example, be associated with the method 300 and/or may be similar in configuration and/or functionality to the systems 100, 200 described in conjunction with FIG. 1 and/or FIG. 2. In some embodiments, the system 500 may be or include a DVR device (and/or other user or network device) such as the DVR devices 110, 210a-c described herein. Fewer or more components that are shown in FIG. 5 may, according to some embodiments, be included in the system 500. In some embodiments, the components 502, 504, 506, 508 of the system 500 may be similar in configuration and/or functionality to the similarly-named components described in conjunction with FIG. 4 herein.

The system 500 may, according to some embodiments, include a DVR device 502, which may further include, for example, a communication path 504, a processor 506 (such as an Intel® PXA270 XScale® processor), and/or memory 508. The system 500 may also or alternatively include an interface such as an Infrared Radiation (IR) interface 510. In some embodiments, the DVR device 502 may be similar to the DVR devices 110, 210a-c described herein. The DVR device 502 may, for example, be associated with a user and/or may store various media, schedules, recommendations, and/or other content in the memory 508. According to some embodiments, the DVR device 502 may be operable to share (e.g., transmit and/or receive) the stored information with other DVR devices via the communication path 504. The communication path 504 may include, for example, a port, cable, and/or connection to an IP and/or other network.

In some embodiments, the system 500 and/or the DVR device 502 may also or alternatively include the remote control interface 510. The remote control interface 510 may be any type and/or configuration of remote control interface that is or becomes known or practicable. The remote control interface 510 may, for example, be or include an IR, Bluetooth®, and/or other wireless and/or wired interface. According to some embodiments, the remote control interface 510 may facilitate communication with the DVR device 502. For example, the user associated with the DVR device 502 may utilize a user device such as an IR remote control to send commands to the DVR device 502 via the remote control interface 510. In some embodiments, the remote control interface 510 may be utilized to communicate with other devices. The remote control interface may, for example, be used to send DVR information to and/or receive DVR information from another DVR device. According to some embodiments, other interfaces in addition to and/or in place of the remote control interface 510 may be included in the system 500.

The several embodiments described herein are solely for the purpose of illustration. Other embodiments may be practiced with modifications and alterations limited only by the claims.

What is claimed is:

1. A method, comprising:
identifying first information associated with a first user of a first digital video recorder; and
providing the first information to a second digital video recorder.

2. The method of claim 1, further comprising:
receiving second information associated with a second user of the second digital video recorder; and
providing the second information to the first user.

3. The method of claim 2, further comprising:
processing the second information.

4. The method of claim 3, wherein the processing includes:
determining at least one behavior of the first digital video recorder based at least in part on the second information.

5. The method of claim 2, wherein the second information includes digital video recorder scheduling information.

6. The method of claim 2, wherein the second information includes recorded media.

7. The method of claim 2, wherein the second information includes information defined by the second user.

8. The method of claim 2, wherein the first and second users are the same.

9. The method of claim 2, wherein the second information is received via an internet protocol network.

10. The method of claims 9, wherein the network includes a wireless network.

11. The method of claim 1, further comprising:
identifying at least one of the second digital video recorder or a user of the second digital video recorder.

12. The method of claim 11, wherein the identifying includes:
locating the second digital video recorder.

13. The method of claim 11, wherein the identifying includes:
accessing a list identifying a plurality of digital video reorder users.

14. The method of claim 1, wherein the first information includes digital video recorder scheduling information.

15. The method of claim 1, wherein the first information includes recorded media.

16. The method of claim 1, wherein the first information includes information defined by the first user.

17. The method of claim 1, wherein the first information is provided via an internet protocol network.

18. The method of claims 15, wherein the network includes a wireless network.

19. An apparatus, comprising:
a storage medium having stored thereon instructions that when executed by a machine result in the following:
identifying first information associated with a first user of a first digital video recorder; and
providing the first information to a second digital video recorder.

20. The apparatus of claim 19, wherein the instructions, when executed by a machine, further result in the:
receiving second information associated with a second user of the second digital video recorder; and
providing the second information to the first user.

21. The apparatus of claim 19, wherein the instructions, when executed by a machine, further result in the:
processing the second information.

22. A system, comprising:
a digital video recorder associated with a first user, comprising:
a processor;
a memory to store digital video recorder scheduling information;
a remote control interface to receive input signals from the first user; and
a communications path to provide the digital video recorder scheduling information to one or more other digital video recorders associated with one or more other users.

23. The system of claim 22, wherein the digital video recorder scheduling information includes recorded media.

24. The system of claim 22, wherein the digital video recorder scheduling information includes information defined by the first user.

25. The system of claim 22, wherein the communications path includes an internet protocol network.

26. The system of claim 22, wherein the digital video recorder scheduling information includes information identifying the one or more other digital video recorders or the one or more other users.
